(19) United States
(12) Patent Application Publication
(10) Pub. No.: US 2008/0256936 A1
(43) Pub. Date: Oct. 23, 2008

(54) Selective Catalytic Reduction Filter and Method of Using Same

(75) Inventor: Bilal Zuberi, Cambridge, MA (US)

Correspondence Address: GEO2 TECHNOLOGIES, 12-R CABOT ROAD, WOBURN, MA, 01801, US

(73) Assignee: GEO2 TECHNOLOGIES, INC., Wobum, MA (US)

(21) Appl. No.: 11/736,388

(22) Filed: Apr. 17, 2007

(51) Int. Cl. F01N 3/10; B01D 53/56

(52) U.S. Cl. 60/299; 422/177; 422/180; 60/274

(57) ABSTRACT

A Selective Catalytic Reduction (SCR) filter is provided for use in emission control systems, for example, on the exhaust gas from an internal combustion engine. The SCR filter has a substrate constructed using bonded fiber structures, which cooperate to form a highly uniform open cell network, as well as to provide a uniform arrangement of pores. The substrate typically is provided as a wall-flow honeycomb structure, and in one example, is manufactured using an extrusion process. In this way, the substrate has many channel walls, each having an inlet surface and an outlet surface. The inlet surface has a uniform arrangement of pores that form a soot capture zone, where soot and other particulate matter is captured from an exhaust gas. A NOx conversion catalyst is disposed inside the channel wall, where NOx and ammonia in the exhaust gas are reacted to less harmful substances. Because of the uniform pore structure and open cell arrangement inside the channel wall, the filter is capable of being heavily loaded with catalyst, while avoiding undue increase in backpressure to the internal combustion engine.

### BACKGROUND

This application claims priority to U.S. patent application Ser. No. 11/695,585, filed Apr. 2, 2007, and entitled “An Emission Control System Using a Multi-Function Catalyzing Filter ”; and is related to U.S. patent application Ser. No. 11/323,429, filed Dec. 30, 2005, and entitled “An Extruded Porous Substrate and Products using the Same”; both of which are incorporated herein in its entirety.

The field of the present invention is the construction and use of filters and catalyzing filters for pollution control in an emission control system. More particularly, the present invention relates to a multifunction filter for use with an internal combustion engine.

Internal combustion engines are essential to modern life. These engines power our cars, trucks, delivery vehicles, emergency generators, manufacturing equipment, farming equipment, and innumerable other machines and processes. Internal combustion engines typically are powered using a hydrocarbon fuel. Most often, this fuel is derived from crude oil, and is in the form of gasoline, diesel, or other liquid fuel. The internal combustion engine has evolved over time to provide excellent performance characteristics, extended durability, and low cost of operation. Due to these characteristics, the internal combustion engine continues to be a main power source for manufacturing, commercial, industrial, transportation, and residential use.

In operation, an internal combustion engine typically combines a hydrocarbon fuel with air, and ignites the mixture to generate an explosive power that is converted into a kinetic mechanical energy. Unfortunately, the burning of hydrocarbon fuels, and in particular fossil fuels, generates highly undesirable pollutants that harm the environment. For example, internal combustion engines generate volatile organic compounds, pollutant gases such as carbon monoxide and various derivatives of NOx, as well as soot and ash. Different types of internal combustion engines have different environmental impacts. For example, diesel engines typically generate far more soot than the gasoline powered engine, while having less environmental impact with NOx. Great strides have been made, primarily due to government regulation, to clean the exhaust from internal combustion engine systems. Larger internal combustion engines now typically have sophisticated engine control systems that monitor and adjust fuel-to-air ratios, as well as monitor other emission control characteristics. These engine control systems may adjust the engine to operate at a new performance or adjust a factor or add extra devices to the emission control system (i.e. after-treatment) to improve emission quality. Although the emission control systems are typically initially provide with a vehicle, additional emission control devices may be added to existing in-service vehicles by adding after-treatment devices. Hybrid vehicles generally fall in the same category when they are not operating on the battery powered mode, and therefore require emission controls when operating their internal combustion engine.

In a typical modern gasoline-powered passenger vehicle, several separate devices are provided for improved emissions control. In most cases, such systems are required to meet or exceed the regulatory emission limits. The vehicle may have two, three, or even more separate catalytic converters for converting various pollutant gases into less dangerous materials. In many countries, a gas powered passenger vehicle currently (2007) does not typically provide separate filtration for particulate matter or soot, even though some recent studies have highlighted the formation of nano-particle soot and secondary organic aerosol emissions from such engines. The vehicle also has a complex engine control system for monitoring air/fuel ratios, and making real-time adaptations to the engine and emission control system for improved emission control. For a typical diesel-powered truck, a large particulate filter is now used for trapping soot and ash, and a sophisticated burn off control system is used for periodically regenerating the filter. Such filtering requirements may apply to heavy duty, medium duty, or even light duty, depending on the particular regulatory jurisdiction. In the regeneration process, the filter is heated sufficiently to burn soot, sometimes in the presence of a catalyst, into relatively harmless exhaustible by-products. For engine systems requiring a greater degree of emission control, after-treatment devices may have to be installed, as in-engine modifications and controls are not enough to meet the regulatory emission limits. After filtration, an additional separate catalytic conversion devices or canisters are provided for oxidation of unburnt hydrocarbons, carbon monoxide and for NOx reduction. Additionally, sometimes cleanup catalyst systems are also needed to reduce leakage of criteria or toxic pollutants.

In some places, such as Europe, more stringent emission control standards require larger diesel delivery trucks to further reduce NOx emissions using systems such as NOx adsorbers, lean NOx traps, lean NOx catalysts, or SCR (selective catalytic reduction). The SCR is either operated by the injection of hydrocarbon in the exhaust stream to reduce the NOx, or by injecting urea which decomposes to form NH₃. These trucks carry an additional refillable supply of urea (either in solution or solid state), which is introduced into the exhaust gas to generate ammonia. In some cases, technologies involving reformer systems and catalysts have been developed to generate on-board urea. The ammonia is reacted in a catalytic conversion device for converting NOx to relatively harmless byproducts, such as N₂.

Even today, a large volume of space is required for emission control devices and systems in both gasoline and diesel vehicles. In particular, most vehicles now require several separate units for the different aspects of after-treatment, for example for filtering and catalytic conversion, each consuming valuable volume in the vehicle, and limiting design options and making the design and manufacturing processes more complex. Further, adding these emission control systems, filters, and catalyzing devices add substantial expense to the cost of a new vehicle, as well as increase maintenance costs.

Governments are continually strengthening emission control standards, and requiring manufacturers to reduce carbon monoxide, NOx, and particulate emission. With the addition of each new regulation, manufacturers are further pressured to add more emission devices, enlarge current emission devices, and provide for more sophisticated emission control systems. Accordingly, over time the volume, cost, and design limitations presented by implementing emission standards becomes a substantial burden on any vehicle manufacturer. Further, these additional emission control devices may negatively affect fuel efficiency. Although these engines will be cleaner, they put additional strain on the world's resources, and contribute to further emission of carbon dioxide, which has been linked to global climate change.

Recently, much attention has been directed to NOₓ reduction in exhausts from gasoline and diesel engines. NOₓ is the generic name for a group of highly reactive gases that contain varying amounts of NO and NO₂. NOₓ, although colorless and odorless, has highly detrimental environmental effects. About half the NOₓ emissions in the world are emitted from motor vehicles, including gasoline and diesel engines. Other significant sources of NOₓ, are typically more stationary facilities, such as electric utilities, industrial, and commercial sources, where NOₓ reduction devices are readily incorporated. Motor vehicles provide a particularly difficult challenge due to the vast number of individual engines, the differences between engines, the changing environmental conditions at each engine, seasonal and geographic differences in fuels, and other unpredictable and dynamic environmental characteristics. Further, this dynamic combustion environment results in a particularly complex set of chemical reactions occurring in the engine, as well as in the multiple and complex after treatment systems deployed on mobile sources of NOx. Accordingly, reducing the level of NOₓ from motor vehicles has lagged behind managing the other sources, such as particulate matter (soot) and CO, but is now of primary importance.

NOₓ is generated in an engine when a hydrocarbon fuel explodes in a confined space of a piston cavity. Under this high temperature and high pressure condition, O₂ and N₂ combine to form NO. As exhaust gases leave the internal combustion engine, the temperature decreases, and a small amount of NO combines with O₂ to form NO₂ (nitrogen dioxide) in a reversible reaction. All engines emit NOₓ in varying degrees.

NOₓ has various detrimental environmental impacts, both to the environment generally and to human health in particular. As for direct environmental impact, NOₓ and volatile organic compounds react with heat and sunlight to form ground-level ozone or smog. Ground-level ozone and smog causes lung damage, and has adverse effects on those most susceptible to decreases in lung function, such as, asthmatics, and people who work or exercise outside. Smog and ground-level ozone also has a negative impact on vegetation and reduces crop yields. NOₓ also reacts with sulfur dioxide in the atmosphere to form acid rain, which falls to Earth with rain, fog, snow, or as dry particles. Acid rain damages or deteriorates cars, buildings, and monuments, as well as causes lakes and streams to become unsuitable for fish, and has other detrimental effects on wildlife. NOₓ also has a more direct affect on humans, by directly deteriorating the respiratory system. NOₓ reacts with ammonia, moisture, and other compounds in the air to form nitric acid and related particles. These particles damage lung tissue, and the small size of the particles penetrate deeply into sensitive parts of the lungs and cause or worsen potentially fatal respiratory diseases such as emphysema and bronchitis. With all these known dangers to NOₓ emissions, governmental agencies around the world are taking strong action to reduce the levels of NOₓ emitted into the atmosphere by internal combustion engines.

Since 1970, the US Environmental Protection Agency (EPA) has required a motor vehicle manufacturers to reduce NOₓ emissions. Significant reductions have been achieved through auto emission controls. As a result, while miles traveled have increased in the US, NOₓ emissions from highway vehicles has decreased by almost 10%. Additional regulations have gone into effect in 2004 and 2007 to further limit NOₓ emissions. Other regulations will be phased in over time, which add even far more stringent regulation of vehicle emissions, including regulations for both diesel and gasoline internal combustion engines. For example, the EPA has defined a stringent standard for model year 2007 and later heavy duty vehicles (>8500 pounds), for both gas and diesel engines. The 2007 has a phase-in period for NOx reduction, but must be fully implemented by 2010. By 2010, diesel engines will be required to produce less than 0.01 g/bhp-hr particulate matter, while emitting less than 0.20 g/bhp-hr of NOₓ. Similarly strict regulations will apply to gasoline engines, but the gas engines have a different phase-in plan.

The European Community is also active in setting aggressive emission control standards. For example, the EuroV emission standard applies to vehicles sold from 2009 and later in the EU. EuroV set the following NOx limits according to vehicle weight and engine type:

| | |
|---|---|
| Passenger car M1, gas | <0.06 g/km |
| Passenger car M1, diesel | <0.18 g/km |
| Light duty commercial (<1305 kg), gas | <0.06 g/km |
| Light duty commercial (<1305 kg), diesel | <0.18 g/km |
| Light duty commercial (<1760 kg), gas | <0.075 g/km |
| Light duty commercial (<1760 kg), diesel | <0.235 g/km |
| Light duty commercial (<3500 kg), gas | <0.082 g/km |
| Light duty commercial (<3500 kg), diesel | <0.28 g/km |
| Large Goods | <2.00 g/kW |

Other stringent regulations for both gasoline and diesel engines are planned or likely in the US, Europe, Asia, and around the world.

Managing and reducing NOₓ emissions represent a significant problem to engine manufacturers and vehicle providers. For example, engine control systems are available that can adjust engine operating conditions to reduce the amount of NOₓ generated within the internal combustion engine. However, if the engine is adjusted so that NOₓ is decreased, the engine is running less efficiently and, therefore has decreased fuel economy and also emits more soot. Accordingly, it is unlikely that engine management alone will significantly impact the NOₓ reductions, especially to levels needed by 2010 in the US and to meet EuroV by 2009. NOₓ traps have also been proposed that are composed of materials (often barium salts) that store NOₓ under lean conditions, and then periodically release and catalytically reduce the stored NOₓ to CO₂ and N₂ during rich conditions. Although NOₓ traps may hold future promise, current direction favors selective catalytic reduction (SCR). SCR is a preferred solution for NOₓ management. In conjunction with engine management controls, SCR systems meter a precise amount of a chemical agent into the engines exhaust system. Often, this reagent is urea. The urea is thoroughly mixed with the hot exhaust gas, and decomposes into ammonia. The resulting gas is subsequently reacted with a catalyst to generate nitrogen and water vapor. Using an SCR system managed by an engine control system, reductions of up to 90% or more are possible.

Such a known SCR system is illustrated in FIGS. 20 and 21. As illustrated in these figures, an engine generates an untreated exhaust gas which is mixed with a gas phase additive prior to being received into an SCR catalyst device. In an SCR system, the gas phase additive is typically urea (NH₂)₂CO, which reacts with the hot exhaust gas to form ammonia NH₃, and carbon dioxide. The gases are received into an SCR catalyst, where the ammonia reacts with NOx in the presence of a catalyst material to be reduced into relatively harmless nitrogen gas. Selection and application of the catalyst is particularly important in systems for mobile internal combustion engines. As opposed to stationary applications, internal combustion engines operate under a much wider temperature window, more variation in mass flow, and have transient duty cycles. Currently, platinum, vanadium oxide or (vanadia), and zeolites are proving effective, although developing health concerns regarding vanadium may limit choices.

Another important consideration is the placement of the SCR catalytic device in relation to other emission control devices. For example, operating the SCR catalyst at low temperatures may present problems both in conversion efficiency and in catalyst durability or survivability. In this regard, the catalyst typically does not reach full efficiency until a relatively high operating temperature has been reached. Further, the SCR catalyst material may be consumed or deactivated during some low-temperature reactions, so continual or prolonged operation in low temperatures may substantially and permanently degrade the performance of the SCR catalyst. Accordingly, it is desirable that the SCR device reach its operating temperature quickly, which suggests that the SCR catalyst be positioned closer to the outlet of the internal combustion engine. Such a system is illustrated in FIG. 20, where the SCR catalyst is positioned close to the internal combustion engine. In this way, NOₓ reduction is performed in the SCR catalyst, and then the reacted exhaust gas is sent to a particulate filter where soot is removed.

However, the exhaust emitted from the internal combustion engine typically contains levels of soot, which may act to clog the SCR catalyst, react or deactivate the catalyst material, or otherwise interfere with effective NOₓ control. As illustrated in FIG. 21, it therefore may be desired to place a particulate filter closer to the internal combustion engine, and therefore the SCR catalyst is able to react a soot-reduced gas. Unfortunately, the arrangement shown in FIG. 21 has a longer light-off period before the SCR catalyst reaches its preferred operational temperatures. In this way, ammonia may slip through the system, catalyst material may be permanently deactivated, and the level of overall NOₓ reduction is undesirable. Lately the formation of additional NO₂ from NO conversion in the upstream DOC and DPF have also been questioned, which affects the chemical reaction balance inside the SCR catalyst system. FIGS. 20 and 21 also show the SCR system having an engine control system. The engine control system typically is a closed loop control system having feedback from measurements taken at various points along the exhaust path. However, for less stringent NOₓ control, an open loop control system may be sufficient.

Selecting the proper SCR catalyst and positioning the SCR device is also complicated in that each SCR catalyst has a different preferred operating temperatures. For example, platinum is most effective in a narrow band of temperatures below about 250° C., with performance quickly deteriorating above that range. Accordingly, a platinum-based SCR catalyst must be positioned to maintain operating temperature in a relatively narrow band. Further, this narrow window for temperature control adds expense and complexity to the overall process design, especially to the engine control system. Vanadia has a higher and wider operational band than platinum, effectively reducing NOₓ from about 300° C. to about 400° C. Even higher temperatures are effective for zeolite (especially Cu, Fe or otherwise substituted zeolites), which is efficient at temperatures over 400° C. Although vanadia and zeolite have wider operating bands, and are therefore more easily integrated into a mobile emission control system, their higher initial temperature requirements may lead to undesirable ammonia slip and efficient or effective NOx control at lower temperatures, for example, at startup. Sophisticated engine control is still required even with vanadia or zeolite SCR systems, as both catalysts degrade at elevated temperatures.

Also, for a practical commercial implication, it is likely that the exhaust systems of FIGS. 20 and 21 would be augmented with other catalytic devices. For example, an oxidation catalyst device may be provided for conversion of hydrocarbon gases and carbon monoxide into carbon dioxide and water, and in some cases, more than one oxidation catalyst will be provided. A typical passenger vehicle may have an oxidation catalyst near the internal combustion engine for providing oxidation immediately after startup and a main oxidation catalysts that performs higher levels of oxidation after an operational temperature is reached. In a specific example, another oxidation catalyst may be provided after the SCR device to oxidize ammonia slip, which is present due to imperfect conversion within the SCR catalyst.

In an SCR system, even under optimal conditions, catalyst is consumed and permanently deactivated. Accordingly, in order for an SCR to effectively manage NOₓ reductions over the expected life of the vehicle, a substantial and heavy loading of the catalyst is typically required. SCR reactions also work well in the case of high residence times for the gas in the reactor and for low gas space velocities. Because of this heavy loading, the SCR catalyst device may restrict the flow of exhaust gases, thereby increasing the backpressure to the engine. Such an increase in backpressure is detrimental to fuel economy, and therefore the SCR catalyst device is sized to reduce the negative impact on that pressure. Of course, these larger SCR devices consume more valuable space in a vehicle, making manufacturing and design more difficult, and also add additional cost.

In a urea SCR system, urea is provided, typically in a water-soluble liquid, although some applications may allow for a solid phase or in-situ generated urea. For the liquid urea system, the urea solution is pumped from a urea tank and sprayed through an atomizing nozzle into the exhaust gas. Thorough mixing of the urea with the exhaust gas and a uniform flow distribution is important to achieving high rates of urea decomposition. Accordingly, a separate mixing device or area may be provided to facilitate improved ammonia formation. Also, a dedicated hydrolysis catalyst may be installed to further facilitate the hydrolysis of urea into ammonia. The SCR catalyst device is sized to assure ammonia molecules and NOx molecules are brought into contact with the catalyst. Indeed, some early SCR catalyst used very low space velocities to provide for high NOₓ reductions and low ammonia slip, but this resulted in very large catalytic device sizes. SCR catalyst device size may be reduced by increasing cell densities or loading more catalyst material into the device. However, increasing cell densities or providing more catalyst material both act to detrimentally affect backpressure characteristics, thereby reducing fuel efficiency and engine performance.

Therefore, there exists a need to provide emission control devices that can efficiently meet current and evolving emission standards for NOx, while minimizing the overall size, cost, and complexity of the emission control system.

### SUMMARY

Briefly, the present invention provides a Selective Catalytic Reduction (SCR) filter for use in emission control systems, for example, on the exhaust gas from an internal combustion engine. The SCR filter has a substrate constructed using bonded fiber structures, which cooperate to form a highly uniform open cell network, as well as to provide a uniform arrangement of pores. The substrate typically is provided as a wall-flow honeycomb structure, and in one example, is manufactured using an extrusion process. In this way, the substrate has many channel walls, each having an inlet surface and an outlet surface. The inlet surface has a uniform arrangement of pores that form a soot capture zone, where soot and other particulate matter is captured from an exhaust gas. A NOx conversion catalyst is disposed inside the channel wall, where NOx and ammonia in the exhaust gas are reacted to less harmful substances. Because of the uniform pore structure and open cell arrangement inside the channel wall, the filter is capable of being heavily loaded with catalyst, while avoiding undue increase in backpressure to the internal combustion engine.

In one example, the SCR filter has a single soot collection zone and a single NOx conversion zone. The NOx conversion zone may be inside the channel wall, adjacent to the inlet surfaces, or adjacent to the outlet surfaces. Accordingly, the position of the NOx conversion zone, as well as the particular catalyst or combination of catalysts, may be selected to support a wide range of emission control requirements. In the NOx conversion zone, a catalyst may be evenly loaded, or may be loaded according to a gradient. The NOx conversion zone may also have multiple catalysts layered onto the fiber structures according to known processes to assist in other catalytic reactions.

In another example, the SCR filter has one or more other gas conversion zones. These other zones may be used for oxidation processes, soot regeneration, or as an ammonia-slip catalyst. These zones may be layered within a channel wall, or may be positioned in separate locations in the filter. In one construction, a first catalyst is applied toward the inlet end of the substrate, and another catalyst is applied toward the outlet end of the substrate. In this way, the channel areas nearer the inlet act as a first gas conversion zone, while the channel areas nearer the outlet act as a second gas conversion zone. In yet another example, the soot collection zone and a gas conversion zone share the same channel area. In this regard, a soot-regeneration catalyst may be disposed in the soot collection area to assist in lower temperature soot burn-off. In another case, a gas conversion catalyst may be disposed in the soot collection area to assist in generating transient molecules that are consumed in other downstream processes. In another illustration, a gas conversion catalyst may be disposed in the soot collection area to assist in converting a pollutant gas to a less harmful substance, thereby increasing the overall conversion efficiently of the filter.

In operation, the SCR filter may be provided in a single device, which is typically in the form of a can. In this way, a single can is able to both effectively trap soot, as well as enable highly efficient catalytic conversion of NOx. Since the SCR filter may be heavily loaded with catalyst, the SCR filter exhibits greatly improved conversion efficiencies, even for relatively slow reactions; has an extended useful life, even in processes where catalyst is consumed or deactivated; and provides sufficient catalyst surface area to meet stringent new emission standards for NOx. Since all this is done in a single can, the engine control system is simplified, less expensive, and easier to design into new vehicles. Importantly, even as a single can solution, the SCR filter does not cause undue backpressure to the engine, and avoids undesirable channeling effects when loading and unloading soot.

### BRIEF DESCRIPTION OF THE DRAWINGS

The invention can be better understood with reference to the following figures. The components within the figures are not necessarily to scale, emphasis instead being placed upon clearly illustrating the principles of the invention. Moreover, in the figures, like reference numerals designate corresponding parts throughout the different views. It will also be understood that certain components and details may not appear in the figures to assist in more clearly describing the invention.

FIG. 1 is a simplified block diagram of a emission control system in accordance with the present invention;

FIG. 2 is a flow chart of an emission control system in accordance with the present invention;

FIG. 3 is a substrate for a multi-function filter in accordance with the present invention;

FIG. 4 is an enlarged sectional view of a channel wall structure for the substrate illustrated in FIG. 3;

FIG. 5 is an enlarged sectional view of a channel wall structure for the substrate illustrated in FIG. 3;

FIG. 6 is an enlarged sectional view of a portion of a single channel wall for the substrate illustrated in FIG. 3;

FIG. 7 is an illustration of a bonded fiber arrangement providing highly uniform pore structures;

FIG. 8 is a scanning electron microscope photograph showing a bonded fiber arrangement providing highly uniform pore structures;

FIG. 9 is an illustration of a bonded fiber arrangement providing highly uniform pore structures;

FIG. 10 is a block diagram showing a process for filtering and catalyzing an exhaust gas using a multifunction filter in accordance with the present invention;

FIG. 11 is a functional block diagram of a wall flow multifunction filter in accordance with the present invention;

FIG. 12 is a flowchart of a process of forming a multifunction filter in accordance with the present invention;

FIG. 13 is a block diagram of a wall flow multifunction filter having multiple gas phase reaction zones; and

FIG. 14 is a flowchart of a process of making a substrate for a multifunction filter in accordance with the present invention;

FIG. 15 is a block diagram of an SCR multifunction filter in accordance with the present invention;

FIG. 16 is a flowchart of the process of using an SCR multifunction filter in accordance with the present invention;

FIG. 17 is a flowchart of making a multifunction filter in accordance with the present invention;

FIG. 18 is an enlarged sectional view of a portion of a single channel wall for an SCR-Filter;

FIG. 19 is an enlarged sectional view of a portion of a single channel wall for an SCR-Filter;

FIG. 20 is a block diagram of a known emission control system having a separate SCR catalyst and a separate particulate filter; and

FIG. 21 is a block diagram of a known emission control system having a separate SCR catalyst and a separate particulate filter.

### DETAILED DESCRIPTION

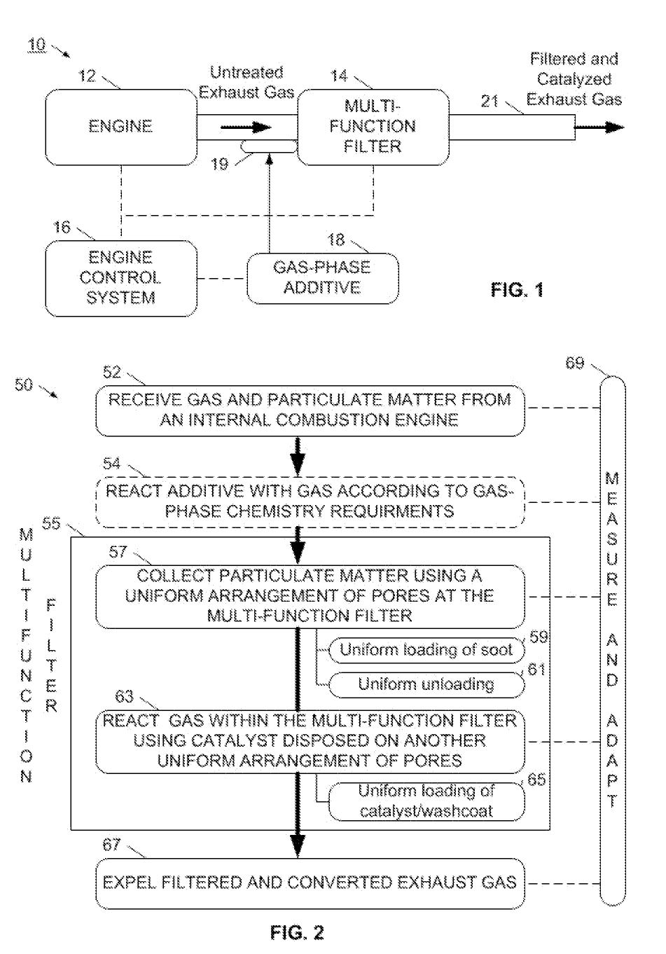

Referring now to FIG. 1, emission control system 10 is illustrated. Emission control system 10 is constructed for use with an internal combustion engine to provide pollution control. As such, emission control system 10 advantageously may be used with gasoline, diesel, or other hydrocarbon-based internal combustion engine systems. Since the design and construction of engines, engine control systems, and general exhaust system components are well known, these will not be described in detail. Emission system 10 has internal combustion engine 12 operating, for example, on diesel or gasoline fuel. Engine 12 emits an untreated exhaust gas containing various pollutants, such as particulate matter, volatile organic compounds (VOC), and pollutant gases. The untreated exhaust gas 19 is received into multi-function filter 14. The multi-function filter 14 is a single discrete device for both filtering particulate matter from the untreated gas, and for facilitating catalytic conversion of one or more pollutant gases. Advantageously, exhaust 21 from multi-function filter 14 is a filtered and catalyzed exhaust gas that complies with new and evolving emission control standards. Importantly, the filtering and catalyzing process has been enabled within a single multifunction filter assembly, reducing the size, complexity or cost of the other emission control devices in the exhaust systems. Accordingly, the multifunction filter 14 consumes less space in a vehicle, may be more conveniently integrated into vehicle aesthetics, and simplifies construction, maintenance, and repair.

In some cases, a gas-phase additive 18 will be mixed with the untreated exhaust gas in mixing chamber 19. This gas-phase additive reacts with one or more gases in the untreated exhaust gas 19 to create an intermediate substance that may be more readily catalyzed or otherwise removed within the multifunction filter 14. Although emission control system 10 is illustrated with a single multifunction filter 14, it will be appreciated that other catalysts and filters may be provided in the overall exhaust path. Emission control system 10 also has engine control system 16 for managing the individual components of emission control system 10. For example, engine control system 16 may communicate with engine 12 to determine performance characteristics, may monitor the multifunction filter 14, and may make adjustments to improve overall pollution control or engine performance. In one example, engine control system 16 may monitor for an undue increase in back pressure in the multifunction filter 14, and in response, initiate a burn-off process to unload accumulated soot. It will be appreciated that engine control system 16 may monitor several aspects of emission control system, and may make adjustments according to the specific engine and exhaust design. Since the design and implementation of engine control systems is well known, engine control system 16 will not be described in detail.

Multifunction filter 14 has been constructed in a way that provides for both 1) highly efficient soot capture, as well as 2) enabling highly efficient gas catalyzing processes, while maintaining desirable back pressure, soot loading, soot unloading, and burn off characteristics. In this way, emission control system 10 provides the first known multi-function filter capable of meeting stringent particulate and pollution control standards evolving in Europe, the United States, and in other countries around the world. Advantageously, use of the multifunction filter 14 provides exceptional particulate and pollution control, while allowing internal combustion engines to meet performance requirements. For example, since multifunction filter 14 has exceptional back pressure characteristics, an associated internal combustion engine is able to more efficiently operate, and thereby maintaining or improving its fuel economy. In this way, the multi-function filter 14 may enable vehicles to emit cleaner exhaust, without the typical degradation to fuel economy. Use of the disclosed multifunction filter 14 thereby protects the earth's atmosphere by providing for effective pollution control, and at the same time helps to reduce dependency on carbon-based fuels by enabling better fuel efficiencies.

Multifunction filter 14 may be better understood with reference to FIG. 2, where a process 50 is described for operation on multifunction filter 14. Multifunction filter 14 receives gas and particulate matter from an internal combustion engine as shown in block 52. In some cases, an additive may be reacted with the gas according to the particular gas-phase chemistry requirements as shown in block 54. Typically, additive mixing is achieved in a mixing chamber prior to the gas being received into multifunction filter 55. In one example, the additive is urea, which is decomposed to form ammonia by the heat from the exhaust. It will be appreciated that other catalyst processes may be used to facilitate improved ammonia formation. The ammonia (decomposed urea) is received into multifunction filter 55, where it reacts with nitrogen oxides in a reduction reaction to produce harmless nitrogen gas. It will also be appreciated that other additives may be used for creating other intermediate products for the removal of other pollutant gases according to application needs.

The exhaust gas is received into multifunction filter 55. The multifunction filter 55 performs two distinct functions within a single substrate: first, highly effective soot capture; and second, it hosts an efficient gas-phase process. In its filtering role, multifunction filter 55 collects particulate matter using a highly uniform arrangement of pores. This highly uniform arrangement of pores has a relatively narrow distribution of pore sizes, as well as a generally open, inter-connected pore structure. This means that soot may be captured in a regular and uniform manner, and in some cases acts as an especially efficient cake filtering structure. With such a highly organized and arranged pore structure and size distribution, a very uniform loading of soot is achieved as shown in block 59. In a similar manner, this same pore structure contributes to a highly uniform unloading of soot as shown in block 61. Uniform loading and unloading is advantageous, as it reduces undesirable channeling effects within the filter. In previous filters, channeling effects occur within a filter as pores fill with trapped soot. In these filters, since there is a wide distribution of pore sizes, and many pore paths are blocked, exhaust gases initially move along a path of least resistance, which typically will be through some set of relatively aligned and large pores. Operating in this state, the filter has a very low back pressure. However, as these initial pore networks clog with trapped soot, the exhaust gas is forced to take alternative paths. While these paths are being established, the filter's backpressure may undergo an undesirable and sizeable increase, and the overall performance of the emission control system declines. This temporary spike in backpressure wreaks havoc on the overall emission control system, complicating design and implementation, and causes irregular emission control performance. For example, the control strategies used for regenerating such filters are often under-utilizing the filter to make sure no backpressure spikes are observed. In contrast, the more regular and uniform distribution provided in multifunction filter 55 avoids much of his channeling effect, thereby maintaining efficiency over the loading and unloading process. The open pore structure of multifunction filter 55 also allows gases to flow more uniformly and freely into internal areas of the multifunction filter. It also makes the porosity inside the wall fully accessible for catalyst loading and gas permeation.

Within the multifunction filter 55, the filtered gas is reacted with one or more catalysts that have been disposed on the internal arrangement of pores. The arrangement of pores within the multifunction filter is also a generally uniform arrangement, and is constructed as a highly open cell network of pores. Typically, a washcoat is disposed on to the substrate surface, which facilitates better adhesion and distribution of the catalyst or catalysts. Advantageously, the uniform nature of the pore structure within the multifunction filter enables a uniform loading of the washcoat and catalyst as shown in block 65. Further, because of the open pore, interconnected pore network, the washcoat and catalyst may be disposed at very high loading levels. These high loading levels are highly advantageous for efficient catalyst processes, as well as desirable to assure long-term survivability. It will also be appreciated that multifunction filter 55 may have a single catalyst for reacting a single pollutant gas, or may have multiple catalysts arranged for reacting multiple pollutant gases. The gas expelled from the multifunction filter 55 has been filtered and reacted as shown in block 67. An engine control system 69 may monitor various aspects of process 50, and a make adaptations for improved emission control or engine performance.

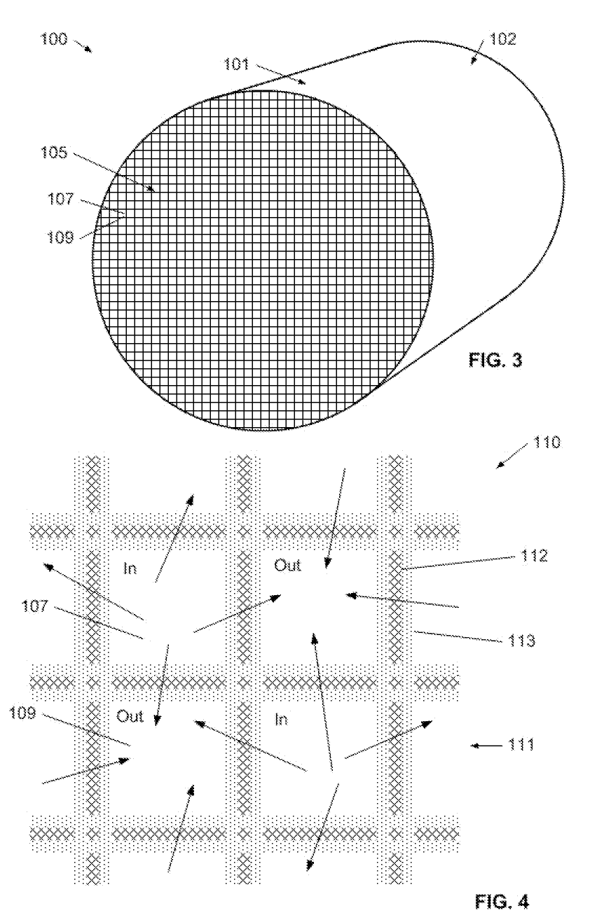

Referring now to FIG. 3, a substrate 100 is illustrated. In one example, substrate 100 may advantageously be used in a multifunction filter, such as multifunction filter 14 described with reference to FIG. 1. While substrate 100 may be manufactured in alternative ways, extrusion has been found to be a particularly efficient and effective process. Generally, the extrusion process mixes together fibers or fiber precursors with pore formers, plasticizers, and fluids to form an extrudable mixture at the proper rheology. The extrudable mixture is then forced through the die of an extruder, thereby generating a green substrate having a honeycomb form. The green substrate is first dried to remove fluids, and then further heated to remove pore formers, volatile organic and inorganic materials, and finally to form a bonded fibrous structure.

It is this bonded fibrous structure that enables the multifunction filter to efficiently act as both a filter and a catalyzing substrate. The bonded fibrous structure is identifiable in its finished form by the uniform arrangement of pores, and the relatively narrow distribution of pore sizes. Although there is a high degree of uniformity, different zones of substrate 100 may have different uniform arrangements. For example, the extrusion process may provide for one geometry of pore structure at or near the surface of each channel wall, while a somewhat different, yet uniform, pore structure may exist more towards the inside or middle of each channel wall. Indeed, these differences in zone pore structures may beneficially be used to adapt substrates for particular filtering and catalytic requirements. The pore-structure can be altered in a controlled fashion by changing the raw material inputs, and the processing processes and parameters during extrusion and sintering.

The bonded fibrous structure may be manufactured in different ways. For example the bonded fibrous structure may be constructed as an arrangement of individual fiber or fiber-like structures that are bonded together at overlapping nodes. In another example, fiber structures include individual fibers, fibers formed into multi-fiber bundles or multi-fiber clumps. These collections of fiber structures bond with other fibers, bundles, or clumps to form a bonded fibrous structure having a highly desirable open, inter-connected pore network. It will also be appreciated that the bonded fibrous structure may use fiber strands in the extrudable mixture, which are then bonded to other fibers during sintering, or the extrudable mixture may have precursors to the fiber or fiber-like structure, whereby the fibers or fiber-like structures form during the sintering process. It will also be understood that the fibers or fiber-like structures may be formed from different materials. For example, organics, carbon, oxides, carbides, nitrides, metals, steels, or metal alloys may be used as the fiber or fiber precursors. It will also be understood that the bond between fibers, fiber bundles, or the fiber-like structures may be ceramic, glass, liquid state sintered, solid state sintered, or another type of sintering bond. For the multifunction filter, it is the unique functional characteristics of the resulting bonded structure that is most meaningful, since there are many ways to commercially manufacture such a fibrous bonded, often extruded honeycomb, structure.

Further detailed discussion of extruding and sintering a bonded fibrous substrate may be found in U.S. patent application Ser. No. 11/323,429, filed Dec. 30, 2005, and entitled An Extruded Porous Substrate and Products using the Same, which is incorporated by reference herein in its entirety. As illustrated in FIG. 3, substrate 100 has many channels formed in a honeycomb pattern. This honeycomb may have a channel density of, for example, 100 to 900 cells per square inch. In some cases where high flow rates are required, even smaller cell densities, as low as 10 cells per square inch, may be used as well. It will be understood that other cell densities may be used for other particular applications. In a particular construction, substrate 100 has alternating channels blocked or plugged at each end. In this way, an inlet channel 107 receives a gas flow, and the gas flows through channel walls into one or more output channels 109. The gas then continues down the outlet channel until it is exhausted. Generally, this type of channel arrangement is referred to as a “wallflow” filter construction.

A washcoat and catalyst is applied to substrate 100 for converting one or more pollutant gases to a less harmful substance. The substrate may host a single type of catalyst, either in a relatively even loading from the inlet side 111 to the outlet side 112, or may be applied with a gradient loading. In this way, a heavier loading may be provided toward one end, while a lesser loading is applied at the other end. Also, the substrate is capable of hosting two or more different catalysts. In one example, a first catalyst is disposed toward the inlet side 101 of the filter, and the second catalyst may be disposed toward the outlet end 102. In this way, the first catalyst may be injected or received through the inlet side 101 openings, and the second catalyst may be injected or received through the outlet side 102 openings. In another example, multiple catalysts may be layered on the fiber structures, or, cell walls may have multiple zones, with each zone having its own catalytic purpose. As an illustration, the surface adjacent to an inlet wall may have a catalyst for assisting in lower temperature soot burn-off, the interior of the channel wall may have a catalyst to assist in NOx reduction, and an area adjacent to the outlet wall may have a cleanup or oxidation catalyst. In this way, a single substrate may efficiently provide or multiple catalytic processes.

FIG. 4 shows an enlarged cross-section of part of the honeycomb structure of substrate 100. Enlargement 110 shows inlet channel 107 adjacent to several output channels, including outlet channel 109. Each of the channel walls 111 is a bonded fibrous structure. Each inlet channel wall has a zone 113 having a particulate loading area having a highly uniform pore structure. For convenience, since soot is the most common particulate, this will be general referred to as a soot capture zone. However, it will be appreciated that other particulates may be used. Typically, the soot capture zone extends from the surface of the channel wall into the initial set of pores. The depth of the soot capture zone will generally be a function of the pore-size, which can be set by changing the size or shape of pore-formers and fibers etc. For example, a larger pore arrangement will result in a fiber structure that acts more like a depth filter, whereas an arrangements of smaller pores will function more as a cake filter. Within this soot capture zone the bonded fibrous structure has a pore structure arranged for an even loading or unloading of soot. This even loading reduces undesirable channeling effects for an operating multifunction filter. Each of the channel walls also has a gas-phased zone in an interior area. The gas-phased zone also has a highly uniform open pore structure, although the structure may vary from the pore structure in the soot capture zone. The open pore structure within the gas-phase zone enables an unusually heavy loading of washcoat and catalyst. In this way a highly efficient and survivable multifunction filter may be made. Often, the catalyst of choice is platinum, although other catalysts may be used. It will also be appreciated that more than one type of washcoat or more than one type of catalyst may be used. In this way, a single multifunction filter is able to filter and react to or more pollutant gases. The soot collection zone may also be coated in the same or a different catalyst. For example, the soot collection zone may also be coated with a washcoat and platinum, which assists in low temperature soot oxidation, although other catalysts may be selected that also help in the regeneration of soot.

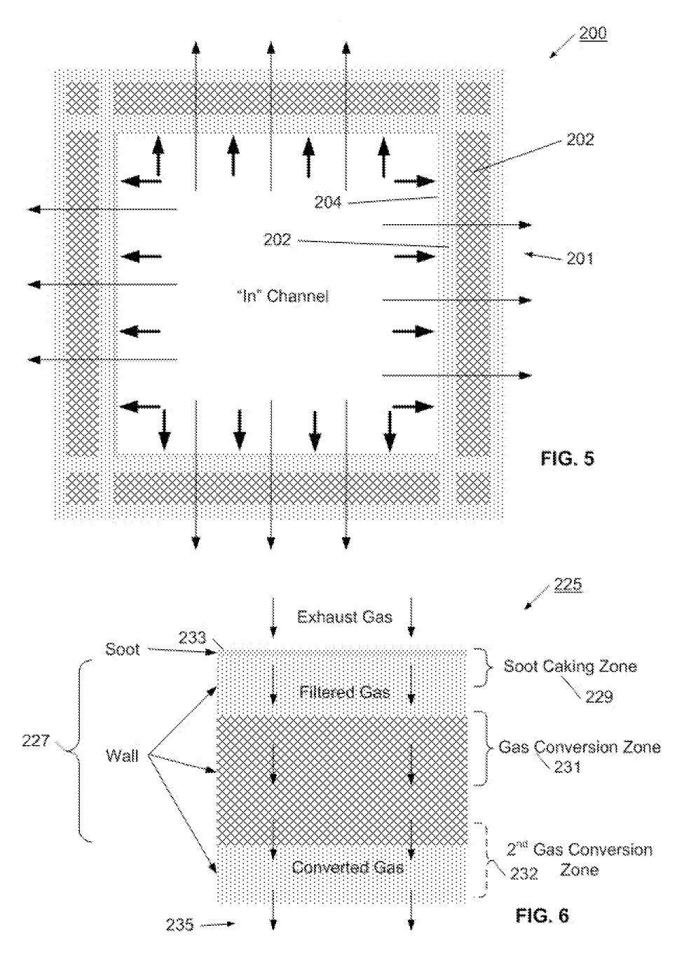

A further enlargement of the channel wall structure is illustrated in FIG. 5. Here, a single inlet channel 200 is illustrated. Channel 200 has channel walls 201 having a soot capture zone 204 and a gas phase zone 202. As illustrated, gas is received into the inlet channel, which then moves through channel walls 201 into an outlet channel. Particulate matter is captured on the soot capture zone 204, while the filtered gas moves into the gas-phase zone 202. In the gas-phase zone, a tortuous gas flow occurs within the uniform open cell network, allowing efficient contact of pollutant gas molecules with the catalyst active surfaces. Upon contact, the pollutant gases are converted to less harmful components. The filtered and reacted gas then moves from the channel walls into adjacent outlet channels, and is then expelled from the multifunction filter.

FIG. 6 shows yet a further enlargement of a channel wall 225 for a multifunction filter substrate. Filter wall 225 is constructed as a bonded fibrous substrate 227. The bonded fibrous substrate 227 has two distinct zones, which may or may not be contiguous. A first soot capture zone 229 has a highly uniform pore structure and arrangement, as well as a reasonably narrow pore-size distribution. A second gas-phase conversion zone 231 is found within the channel wall. The gas-phase zone also has a highly uniform pore structure, although the pore structure may be different from that of the soot capture zone 229. Exhaust gas is received at the inlet channel wall, typically from an internal combustion engine. The exhaust gas typically has both particulate matter and pollutant gases. The exhaust gas first passes through the soot capture zone 229, where the soot 233 is captured at or near the surface of the inlet channel wall. The filtered gas continues through to the gas-phase zone 231, where the gas pollutant molecules contact catalyst, and are converted to less harmful gases. For example, CO may be converted to CO₂ in an oxidation process, or NOx may be converted in a NOx reduction process. The filtered and reacted gas is then exhausted into outlet channel 235. Optionally, another gas conversions zone 232 may be layered in the channel wall. The second zone may be used to support conversions of a second pollutant gas. In this way, the first gas zone 231 may convert a first pollutant, such as NOx, and the second gas zone 232 may convert a second pollutant, such as CO or VOCs. Although the second gas zone 232 is illustrated downstream from the first gas zone, it will be appreciated that it may be located upstream, for example, adjacent the soot collection zone 229.

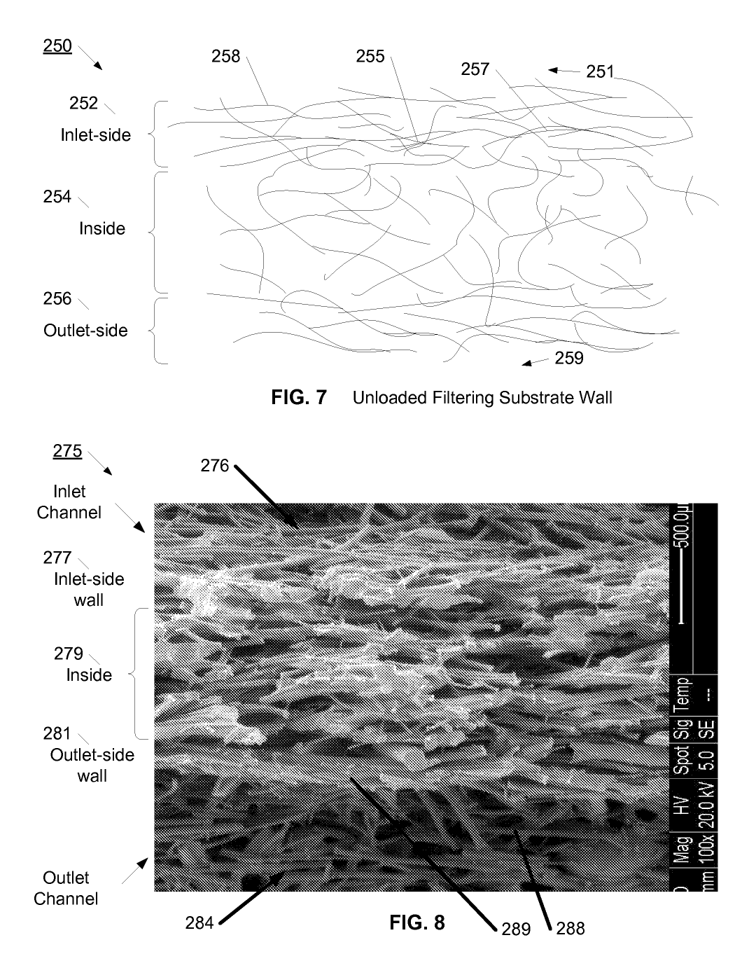

FIG. 7 shows a simplified diagram of a channel wall 250 similar to channel wall 225 described with reference to FIG. 6. Channel wall 250 has is positioned between an inlet channel 251 and an outlet channel 259. The channel wall 250 is a bonded fibrous substrate, having individual fibers 258, fiber bundles 257, and clumps of fibers 255 that are bonded together to form an open pore network. This open pore network further has a highly uniform pore arrangement, due to the consistent physical characteristics of the fibers or fiber like structures. Channel wall 250 has a soot capture zone 252 for capturing particulate matter and passing filtered gas into the gas-phase zone 254. The gas-phase zone also has a highly uniform pore structure, although the pore structure may be different than the pore structure in the soot capture zone 202. As exhaust gas passes through the gas-phase zone, pollutant molecules react with catalyst, forming less harmful gases. The surface adjacent the outlet channel has a pore structure similar to the soot capture zone, however is used primarily for structural support of the channel wall 250. In another example, a different catalyst may be disposed in the outlet side 256 as opposed to the catalyst in the gas-phase zone 254. In such a case, the outlet side 256 would act as a second gas-phase zone in the multifunction filter.

Referring now to FIG. 8, and scanning electron microscope (SEM) image of a channel wall 275 illustrated. Channel wall 275 is a cross-sectional view showing an inlet channel 276 and an outlet channel 284. The channel wall 275 is a bonded fibrous structure 276, having individual fibers 288, fiber bundles 284, and fiber clumps 289 bonded together in an open pore network. Although wall 275 uses fibers, it will be understood that other materials may be used to effect the functionality of fiber. For example, fiber-like structures may be introduced in an extrusion mix, with fiber-like structures formed during the sintering process. Accordingly, for the multifunction filter, it is the unique functional characteristics of the resulting bonded structure that is most meaningful, since there are many ways to commercially manufacture such a fibrous bonded structure. In operation, and exhaust gas is received from the inlet channel 276, which passes through the soot capture zone 277, where soot captures at or near the surface. The filtered gas continues through to the gas-phase zone 279, where gas molecules react with catalyst to form less harmful materials. The gas is then exhausted into outlet channel 284. The outside wall 281 provides additional structural integrity for the channel wall 275. As illustrated, the soot capture zone 277 has a highly uniform pore structure, but is different than the highly uniform pore structure in the gas-phase zone 279.

In manufacturing the multifunction filter for channel wall 275, mullite fibers were mixed with approximately 44 micron (325 mesh) particle size carbon as a pore former, colloidal silica, organic and inorganic binders and plasticizers, along with water. The mixture was aggressively and thoroughly mixed to an extrudable rheology. A piston/ram extruder was used to extrude a green substrate at 200 cells per square inch. The green substrate was dried in an RF oven, and then heated to about 1000 degrees Celsius for approximately 28 hours to burn out organic materials, and sintered at 1500 degrees Celsius for about one hour. After cooling, the multifunction filter can be coated with washcoat, having one or more catalysts applied, and be secured into a can, canister, or other container. Although a specific recipe for manufacturing a multifunction filter is described, it will be appreciated that many other fibers, fiber precursors, pore formers, plasticizers, bonding agents or precursors or fluids may be used. It will also be appreciated that other types of machines and processes may be used for mixing, extruding, drying, and sintering.

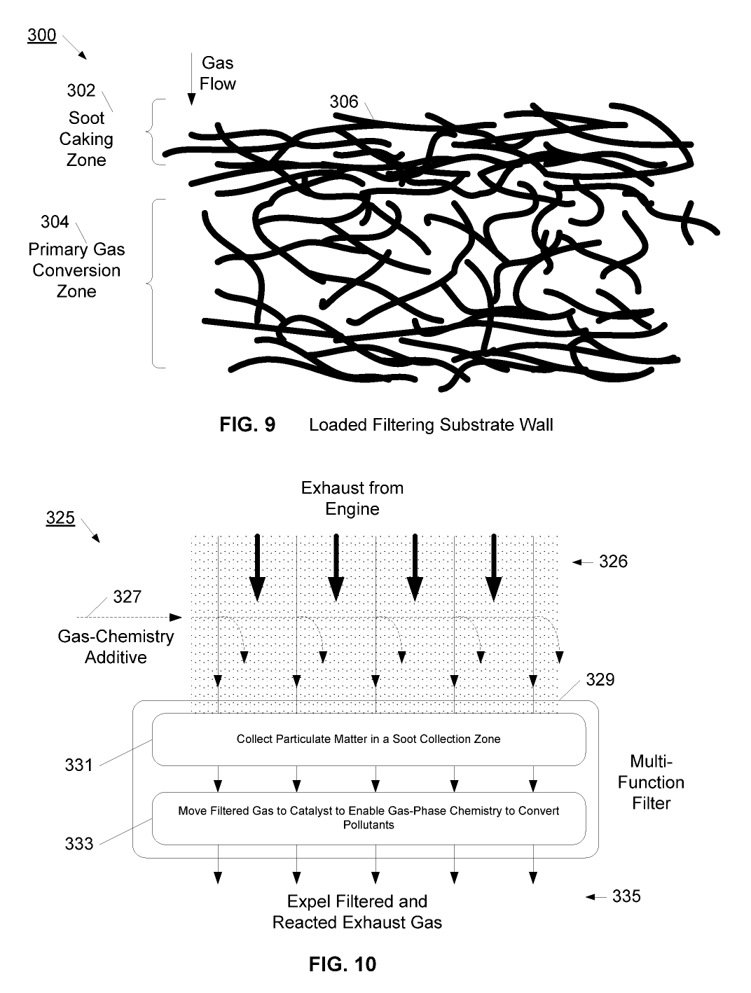

Referring now to FIG. 9, another cell wall 300 is illustrated. Cell wall 300 shows a cell wall loaded with washcoat and catalyst. Accordingly, fibers 306 are heavily loaded with washcoat and one or more types of catalyst. Even though the fibers, fiber bundles, and fiber clumps are heavily loaded with washcoat and catalyst, an effective soot capture zone 302 is present, and the gas-phase zone 304 allows for relatively unrestricted flow. In this way, even when fully loaded with catalyst and washcoat, a highly efficient multifunction filter is provided, with both excellent back pressure characteristics and effective emission control. It will be appreciated that washcoat and catalyst loading will be determined according to application specific requirements, including the level of conversion required within the filter, the size of the filter, the expected flows, and the expected life. Generally, the need for heavier catalyst loading will increase as more demanding emission requirements come into effect. The multi-function filter may be loaded with washcoat and catalyst at a loading rate of 10 grams per cubic foot, 20 grams per cubic foot, and 30 grams per cubic foot or more. In some instances, washcoat and catalyst loadings of 10 to 400 grams per cubic foot may be necessary. It will be appreciated that heavier catalyst loadings may be desirable to support multiple catalysts, to support conversions that consume or degrade catalyst, or to allow for more efficient conversions for slower reactions. By enabling a heavier loading of catalyst, the multifunction filter allows a single substrate to perform functions previously implemented only in multiple substrates in multiple devices. Importantly, even with these heavy load requirements, the resulting multifunction filter may operate with an impact on back pressure that is 0% to 50% increase over the back pressure of the filter without the washcoat and catalyst. This means, that even when fully loaded with washcoat and catalyst, the multi-function filter does not cause an undue backpressure to the engine. In this way, the overall engine system is able to maintain fuel efficiency and meet performance goals, even when the multifunction filter is heavily loaded.

Referring now to FIG. 10, a general process for using a multifunction filter is illustrated. In process 325 exhaust gas is received from an internal combustion engine as shown at block 326. In some cases, a gas-chemistry additive may be added as shown at 327. This additive is mixed with exhaust gas to form a material that is more easily reacted, filtered, or catalyzed within the multifunction filter 329. The gas is received into the multifunction filter 329 where a soot collection zone 331 first captures soot or other particles or particulate matter. The filtered gas is then passed into a gas-phase zone as shown at block 333. In gas-phase zone 333, pollutant gas molecules contact catalyst, and react to form less harmful materials. The filtered and reacted gas is then exhausted as shown at 335. It will be appreciated that gas reactions may start as soon as there is contact between the gas phase species and the solid phase catalyst. Depending on the flow rates, flow patterns, and turbulence, the reaction can be pore diffusion limited, mass transfer limited, or chemical concentration limited.

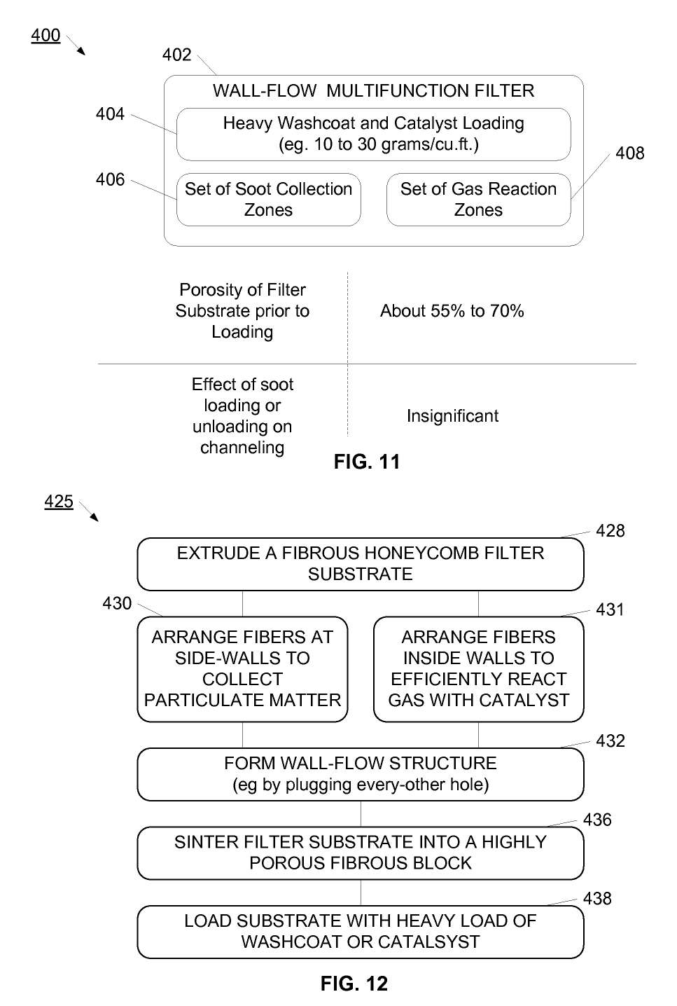

FIG. 11 shows a multifunction filter 400 having a single bonded fibrous substrate 402. The fibrous substrate 402 is heavily loaded with washcoat and catalyst as shown at block 404. Although the particular level of loading is application-specific, loads of 10 to 400 grams per cubic foot or more may be advantageously used. The multifunction filter 452 also has a set of soot collection zones 406, typically positioned on the surface walls for inlet channels of the filter. The multifunction filter 402 also has a set of gas reaction zones 408. These gas reaction zones are typically inside the channel walls of the multifunction filter. Prior to washcoat and catalyst loading, the fibrous substrate 402 typically has a porosity of about 55% to about 70%. It will be appreciated other porosities may be selected according to application needs. Importantly, loading or unloading soot from the soot collection zone has an insignificant channeling effect.

Referring now to FIG. 12, a process of making a multifunction filter is illustrated. Process 425 uses an extrusion process to extrude a honeycomb filter substrate as shown in block 428. This honeycomb substrate has a fiber arrangement on the surface walls particularly constructed to have a highly uniform pore structure for collecting target particular matter as shown at block 430. In this way, specific fiber diameters, sizes of pore formers, and amounts of organic material are selected to construct a pore structure for the target particular matter. Fibers are also arranged inside the walls to form a uniform open, inter-connected pore network for facilitating gas contact with the catalyst as shown at block 431. The fibrous substrate is made into a wallflow structure by plugging every other hole at each end as shown in block 432. The green substrate is dried and sintered into a bonded fibrous block as shown in 436. The substrate is then loaded with a heavy load of washcoat and catalyst as shown in block 438. In one example, the loading of washcoat and catalyst may exceed even 30 grams per cubic foot.

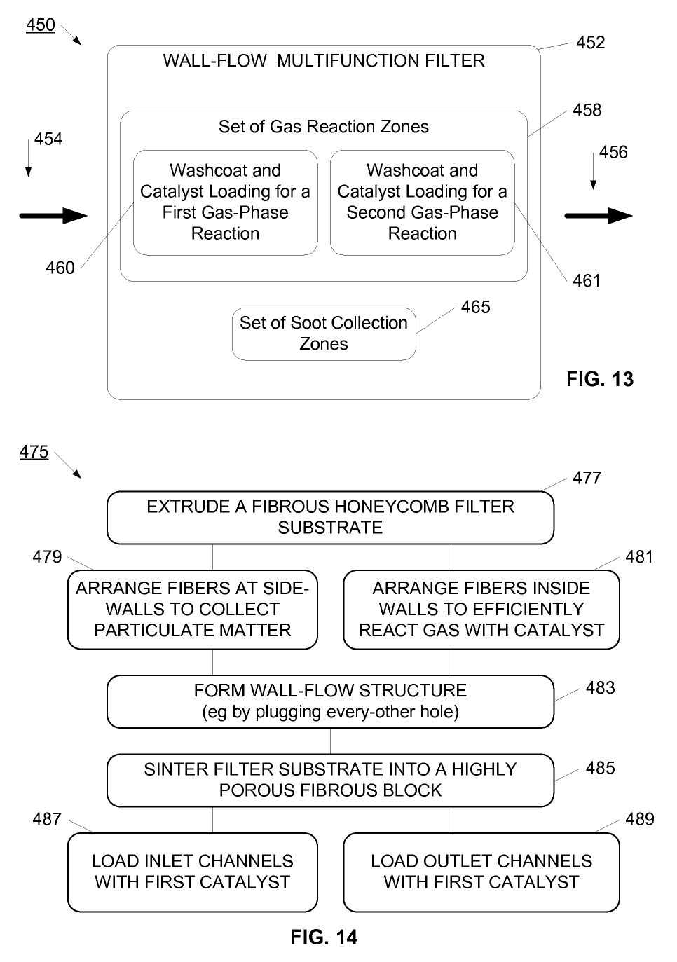

Referring now to FIG. 13, another wallflow multifunction filter 450 is illustrated. Multifunction filter 450 has a bonded fibrous substrate 452 as previously discussed. The multifunction filter 452 has a set of soot collection zones 465 arranged to capture soot in a highly uniform arrangement of pores. The multifunction filter 452 also has a set of gas-phase reaction zones. Here, the filter has multiple zones, with each zone having a catalyst for reacting a different pollutant gas. For example, zone 460 has a washcoat and catalyst for reacting a first pollutant gas, while zone 461 has a different catalyst for reacting another pollutant gas. Accordingly, an inlet gas 454 is filtered through one or more soot collection zones 465 and then received into the gas-phase reaction zones. Each zone reacts a different pollutant gas, thereby exhausting a filtered and dual reacted gas 456.

FIG. 14 shows a process 475 for manufacturing the multifunction filter 450 illustrated in FIG. 13. Process 475 extrudes the fibrous honeycomb filter substrate as shown in block 477. The extrusion process arranges fibers in the soot collection zone 479, as well as fibers in the gas-phase zone 481. Every other hole is plugged to form a wallflow structure 483, and the block is dried and sintered into a bonded fibrous substrate. A washcoat may be applied to the entire substrate, and then a first catalyst is applied through the inlet channels as shown at block 487. A second catalyst may be applied through the outlet channels as shown in block 489. In this way, a soot collection zone is at or near the surface of inlet channel walls, a first gas-phase zone exists inside channel walls, and a second gas-phase zone exists at or near the outlet channel wall. It will be appreciated that other processes may be used for applying washcoat and catalyst to a bonded fibrous substrate.

With reference to FIGS. 1 through 14, a general multifunction filter has been described. This multifunction filter is intended to be adapted to particular and specific emission control requirements. For example, the multifunction filter may have its soot collection zone constructed for capturing one or more specific particle sizes, while the gas-phase zone may be arranged to support the loading of a specific washcoat and catalyst. Accordingly, the multifunction filters described in FIGS. 1 through 14 should not be limited to any particular structure, engine, fuel type, particular matter, or catalyst.

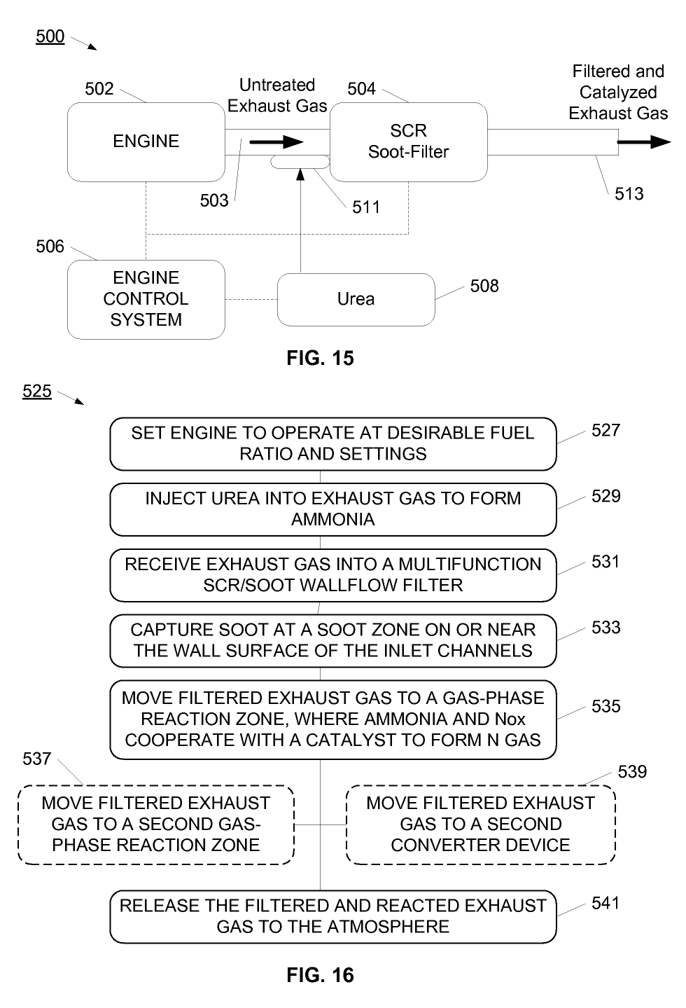

Referring now to FIG. 15, a simplified SCR filter system 500 is illustrated. This is an example of the integration of the SCR functionality onto a ceramic particulate filter SCR filter system 500 is similar to the general multi-function filters and systems described with reference to FIGS. 1 to 14, and therefore will not be described in detail. The SCR filter system 500 has an internal combustion engine 502, which emits an untreated exhaust gas 503. In one example, engine 502 is a diesel powered engine, although gasoline or other fuel sources may be used. The untreated exhaust gas 503 is mixed with the chemical-additive urea 508. An engine control system 506 determines a precise amount of urea 508 to meter or inject into the exhaust gas 503 at mixing area 511. The mixing area may be a separate mixing chamber, or may be an atomizing nozzle that assists in injecting and thoroughly mixing the urea into the exhaust gas 503. The urea is heated by the exhaust gas 503 to form ammonia. In some cases, an additional hydrolysis catalyst or process may assist in more complete conversion.

The exhaust gas, which now includes ammonia, is received into SCR filter 504. SCR soot-filter 504 performs at least two distinct functions. First SCR soot-filter 504 traps particulate matter in a soot collection zone, and second, to SCR soot-filter 504 has a gas-phase zone that reacts NOx with ammonia in the presence of a catalyst to reduce the NOx to harmless nitrogen gas. The chemical reaction of this reduction can be expressed in at least three ways:

4NO+4NH₃+O2→4N₂+6H₂O

6NO₂+8NH₃→7N₂+12H₂O

2NH₃+NO+NO₂→2N₂+3H₂O

In some cases, SCR soot-filter 504 may perform additional tasks, such as assist in hydrolysis or oxidation reduction. After passing through SCR soot-filter 504, the filtered and catalyzed exhaust gas 513 is passed to other emission control devices, or may be exhausted to the atmosphere through a muffler, sound abatement, or other device.

Typically, urea 508 is provided as a water-soluble solution. However, it will be appreciated that urea may be provided in other liquid or solid forms, or generated (from H₂) on board using fuel reformers. Further, it will be understood that the urea 508 may be mixed with other additives, for example, to provide an anti-freeze effect to lower the urea solution freezing point. In the SCR soot-filtered 504, the catalyst may be provided as platinum, zeolites, vanadia, or other appropriate catalyst, such as copper or iron-based formulations. It will be appreciated that as more effective and efficient catalyst products are found, they may be advantageously used in SCR soot-filter 504. More specifically, due to the highly efficient utilization of catalyst within the open pore structure of SCR filter 504, SCR filter 504 exhibits better conversion efficiencies in a given volume, even while it effectively traps soot within the same filter canister. In this way, as compared to previous SCR systems, SCR system 500 provides superior filtration, excellent conversion efficiencies, and enables a more compact design and construction.

The SCR filter system 500 enables a single substrate to 1) filter soot from an exhaust gas, 2) reduce NOx with sufficient efficiency to meet stringent NOx and particulate matter standards; and 3) maintain engine fuel efficiency by not unduly increasing backpressure. For example, the SCR filter system 500 enables a single substrate, in a single canister, to be installed on a vehicle such that the vehicle meets 2010 EPA and EuroV NOx/soot standards. As will be appreciated, the 2010 EPA and EuroV standards are complex and cover a wide range of vehicles, but a few specific examples will illustrate some to the vehicles that may benefit from the use of the SCR filter system 500. It will be appreciated that other classes of vehicles may benefit, and that system 500 may be used to meet other current or evolving standards using a single substrate. Although only EPA (US) and EuroV (EU) are specifically identified, it will also be understood that other regions and countries have vehicle regulations that may benefit from the single-substrate solution provided by SCR filter system 500. Some specific examples

| STANDARD | VEHICLE | PM | NOx | |
|---|---|---|---|---|
| 1) EPA 2010-Diesel | Heavy Duty (>8,500 lbs gw) | <.01 bhp-hr | <0.20 | bhp-hr |
| 2) EPA 2010-Gasoline | Heavy Duty (>8,500 lbs gw) | <.01 bhp-hr | <0.20 | bhp-hr |
| 3) EuroV | Large Goods Vehicle | — | <2.00 | g/kWh |
| 4) EuroV-Diesel | Light Duty Commercial | — | <0.28 | g/km |
| | (>1760 kg & <3500 kg) | | | |
| 5) EuroV-Gasoline | Light Duty Commercial | — | <0.82 | g/km |
| | (>1760 kg & <3500 kg) | | | |
| 5) EuroV-Diesel | Light Duty Commercial | — | <0.234 | g/km |
| | (>1305 kg & <1760 kg) | | | |
| 6) EuroV-Gasoline | Light Duty Commercial | — | <0.75 | g/km |
| | (>1305 kg & <1760 kg) | | | |
| 7) EuroV-Diesel | Light Duty Commercial | — | <0.18 | g/km |
| | (<1305 kg) | | | |
| 8) EuroV-Gasoline | Light Duty Commercial | — | <0.06 | g/km |
| | (<1305 kg) | | | |
| 9) EuroV-Diesel | Passenger Car (M1) | — | <0.18 | g/km |
| 10) EuroV-Gasoline | Passenger Car (M1) | — | <0.06 | g/km |

Referring now to FIG. 16, an SCR-filter process 525 is illustrated. Process 525 may operate on an SCR filter system, such as SCR filter system 500 described with reference to FIG. 15. In process 525, an engine control system sets an engine to operate at a desirable fuel ratio and settings as shown in block 527. In this way, the engine control system may adjust the amount of NOx initially created, as well as adjust the amount of oxygen available for subsequent devices and processes in the exhaust system. Urea is injected into the exhaust system as shown on block 529. The urea is thoroughly mixed into the hot exhaust gas so that it decomposes to form ammonia. The reactants in the exhaust gas flow into an SCR-filter as shown in block 531. The SCR soot-filter is a wallflow filter having a honeycomb pattern with alternating inlet and outlet channels.

The filter has a soot capture zone on or near the inlet walls of the inlet channels as shown in block 533. Advantageously, the soot capture zone is formed using a highly uniform arrangement of pores. This highly uniform arrangement of pores facilitates an exceptionally even loading of soot particles, which minimizes any undesirable channeling effects. After the soot has been trapped at or near the surface of the inlet channel walls, the gas moves inside the channel wall into a gas-phase reaction zone, where platinum, zeolites, vanadia, or other NOx catalyst has been disposed. To increase the effectiveness of the catalyst, it will be appreciated that one or more washcoats may be disposed prior to depositing the catalyst. The catalyst facilitates the reduction of ammonia and nitrogen oxides into nitrogen gas and water, which are harmlessly released into the atmosphere as shown in block 541. In some cases, the SCR-filter may have another gas-phase zone as show one in block 537, for example, on the wall surface of the output channel. In this arrangement, the exhaust gas passes through the soot capture zone on the inlet channel wall, moves through the gas-phase zone inside the channel wall, and passes through this second gas-phase zone as the gas exits the channel wall into the output channel. In this way, another catalytic reaction they be supported, such as an oxidation reduction. In another example, a separate catalyzing or filtering device may be arranged downstream in emission system as shown in block 539.

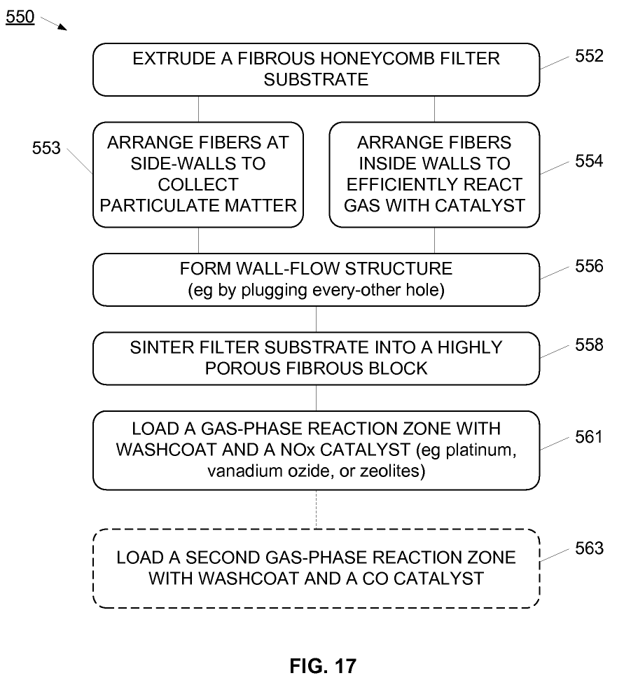

Referring now to FIG. 17, a process for making an SCR-filter is illustrated. Process 550 extrudes a fibrous honeycomb filter substrate as shown in block 552. As previously described, these fibers may be ceramic, metal, silicon carbide, or other fiber material. The fiber it may be provided as fiber strands, or may be provided as precursors that form a fiber-like structure during a sintering process. The extrudable mixture also has pore formers, plasticizers, fluids, and other materials mixed to a rheology for proper extruding as previously described. The honeycomb substrate has a fiber arrangement on the surface walls particularly constructed to have a highly uniform pore structure for collecting soot as shown at block 553. Rearranging of pores may be selected according to the type of internal combustion engine and the expected soot loading. For example, pore size and arrangement may be adjusted according to whether the internal combustion engine is a gasoline engine or diesel engine. In this way, specific fiber diameters, sizes of pore formers, and amounts of organic material are selected to construct a pore structure for the target soot. Fibers are also arranged inside the walls to form a uniform open cell network for facilitating ammonia contact with the catalyst as shown at block 554.

The fibrous substrate is made into a wallflow structure by plugging every other hole at each end as shown in block 556. The green substrate is dried and sintered into a bonded fibrous block as shown in 558. It will be understood that in some cases the plugging process of block 556 may be performed after the sintering process of a 558, depending on manufacturing process. In sintering process of 558, the bonded fibrous structure may be formed in different ways. For example the bonded fibrous structure may be constructed as an arrangement of individual fiber or fiber-like structures that are bonded together at overlapping nodes. In another example, fiber structures include individual fibers, fibers formed into multi-fiber bundles or multi-fiber clumps. These collections of fiber structures bond with other fibers, bundles, or clumps to form a bonded fibrous structure having a highly desirable open pore network. It will also be appreciated that the bonded fibrous structure may use fiber strands in the extrudable mixture, which are then bonded to other fibers during sintering, or the extrudable mixture may have precursors to the fiber or fiber-like structure, whereby the fibers or fiber-like structures form during the sintering process. It will also be understood that the fibers or fiber-like structures may be formed from different materials. For example, ceramics, silicon carbide, or metals may be used as the fiber or fiber precursors. It will also be understood that the bond between fibers, fiber bundles, or the fiber-like structures may be ceramic, glass, liquid state sintered, solid state sintered, or another type of sintering bond. For the SCR-filter, it is the unique functional characteristics of the resulting bonded structure that is most meaningful, since there are many ways to commercially manufacture such a fibrous bonded structure.

The substrate is then loaded with a heavy load of washcoat and catalyst as shown in block 561. Several techniques used for coating ceramic honeycomb substrates in laboratory or commercial environments are known in the field. Additional steps may be taken to specifically place the washcoat and catalyst in certain areas, example in a zoned or layered coating, to place the catalysts where desired. Additionally the particle size of the washcoat/catalyst, or the suspension slurry concentrations may be adjusted depending on the coating levels and penetration into wall required. The catalyst may be selected for its ammonia/NOx conversion efficiency, operating temperature/chemical ranges, and lifecycle characteristics. It will be understood that more than one type of catalyst may be used, and different types of catalyst may work better in different specific applications. For example, platinum may work more efficiently in relatively low temperature applications that can be tightly controlled, whereas vanadia or zeolites may be more effective in other hotter and less controlled applications. It will be appreciated that washcoat and catalyst loading will be determined according to application specific requirements, including the level of conversion required within the filter, the size of the filter, the expected flows, and the expected life. Generally, the need for heavier catalyst loading will increase as more demanding emission requirements come into effect. The SCR filter may be loaded with washcoat and catalyst at a loading rate of 10 grams per cubic foot, 20 grams per cubic foot, and 30 grams per cubic foot or more. In some instances, washcoat and catalyst loadings of 10 to 400 grams per cubic foot may be necessary. It will be appreciated that heavier catalyst loadings may be desirable to support multiple catalysts, to support conversions that consume or degrade catalyst, or to allow for more efficient conversions for slower reactions. By enabling a heavier loading of catalyst, the SCR filter allows a single substrate to perform functions previously implemented only in multiple substrates in multiple devices. Importantly, even with these heavy load requirements, the resulting SCR filter may operate with an impact on back pressure that is 0% to 50% increase over the back pressure of the filter without the washcoat and catalyst. This means, that even when fully loaded with washcoat and catalyst, the SCR filter does not cause an undue backpressure to the engine. In this way, the overall engine system is able to maintain fuel efficiency and meet performance goals, even when the SCR filter is heavily loaded.

In an optional construction, a second gas-phase reaction zone may be created by depositing a second catalyst in a different area of the SCR-filter as shown in block 563. For example, this second gas-phase zone may be an oxidation zone downstream from the soot capture zone and the first gas-phased zone. In this arrangement, the second gas-phase zone may perform an oxidation process, such as the conversion of carbon monoxide to carbon dioxide. In another example, the second gas-phased zone is a hydrolysis zone for assisting in decomposition of urea to ammonia. In this case, the hydrolysis zone is placed at or adjacent to the soot capture zone, and provides for more complete decomposition of urea to ammonia before the gas is received into the first gas-phased reaction zone. The second gas-phase zone may also provide an ammonia-slip catalyst for conversion of ammonia that is not consumed in the NOx reaction processes. In some cases, excess ammonia will be created, and if not reacted, will be emitted as a pollutant gas. Accordingly, the ammonia-slip zone enables ammonia conversion on the same substrate as the NOx reduction, eliminating the need for some separate down-stream slip converter. The second conversion zone may be positioned separately and distinctly from the NOx conversion zone, or some overlap may be accommodated. In another arrangement, multiple catalysts may be layered in the same area of the fibrous substrate. In this case, multiple catalysts are disposed on the same substrate, which facilitate multiple catalytic conversions, or are arranged such that one conversion supports the next conversion. Accordingly, multiple conversion zones may be in separate areas of the substrate, may be arranged as stacked layers in the substrate, or may be layered as multiple catalysts disposed on the same substrate. It will be understood that other zone arrangements and uses may be substituted.

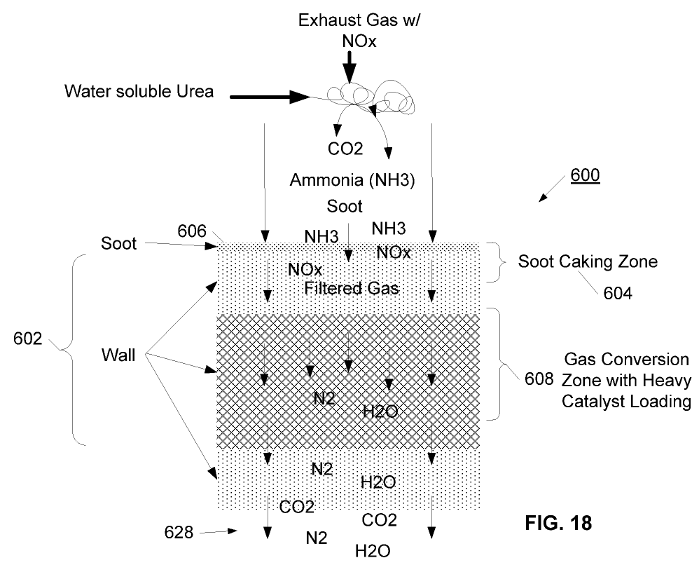

Referring now to FIG. 18, an enlarged cross section of a channel wall structure 600 is illustrated. Channel wall 602 has an exhaust gas from an internal combustion engine being mixed with a water soluble urea at a mixing area. The heat of the exhaust decomposes the urea into carbon dioxide and ammonia, as well as other byproducts according to known chemical processes. This reacted gas is received at an arrangement of highly uniform pores at an inlet channel wall. Soot 606 in the gas is evenly collected at this uniform pore structure, providing for a highly uniform loading process. This highly uniform soot-loading process at the soot taking zone 604 avoids undesirable channeling effects.

The filtered gas is received into a gas conversion zone 608, which has been heavily loaded with a washcoat and an appropriately selected catalyst. The gas conversion zone 608 is constructed to have a highly uniform open cell network, which facilitates a heavy loading of washcoat and catalyst, without providing an undue back pressure to the engine. The catalyst has been selected according to efficiency requirements, as well as expected performance and environmental conditions. As previously described, this catalyst may be platinum, palladium, zeolites, vanadia, barium oxide/nitrate, or other NOx/ammonia catalyst. The catalyst assists in reacting NOx and ammonia to form nitrogen gas and water, which is passed into outlet channel 628 of the SCR-soot filter. In the SCR-filter of FIG. 18, the channel wall has a single soot collection zone 604 and a single gas conversion zone 608. However, it will be appreciated that additional zones may be provided to support additional filtering and catalytic requirements.

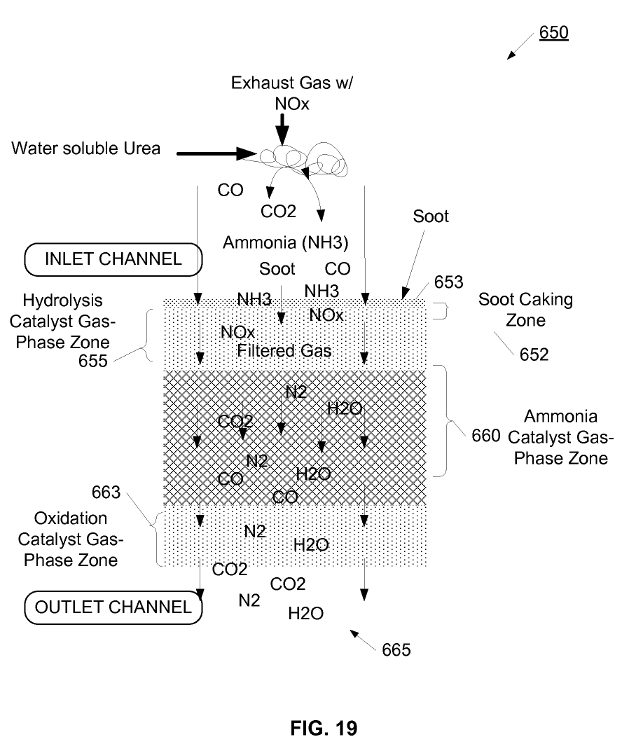

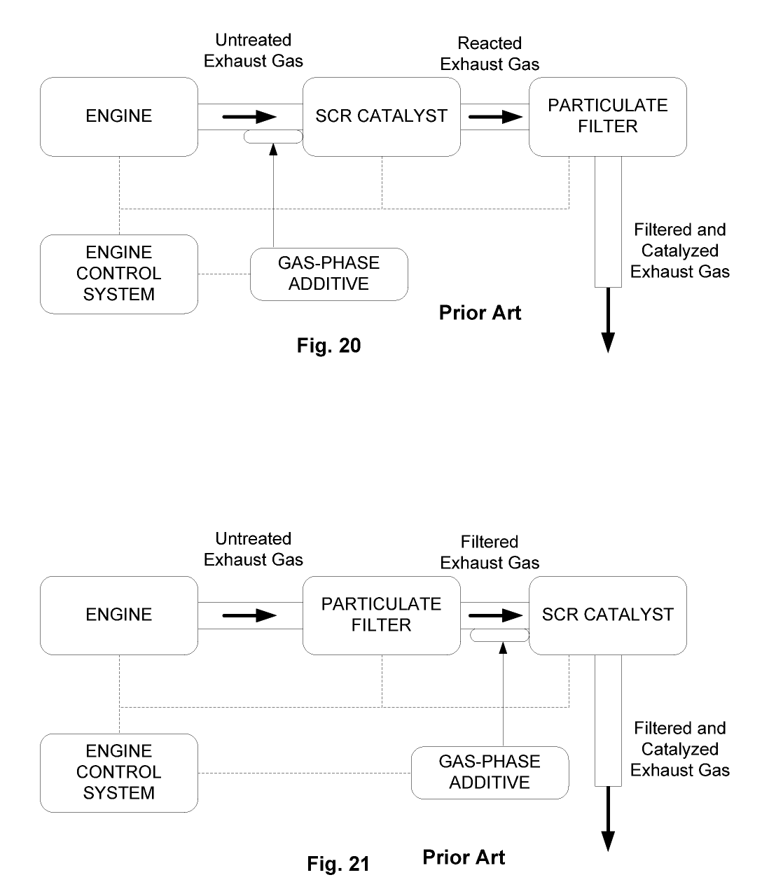

Referring now to FIG. 19, an enlarged cross section of a channel wall structure 650 is illustrated. The channel wall has an exhaust gas from an internal combustion engine being mixed with a water soluble urea at a mixing area. The heat of the exhaust decomposes the urea into carbon dioxide and ammonia, as well as other byproducts according to known chemical processes. In some cases, additional conversion may be desired, so a hydrolysis catalyst gas-phase zone 655 is provided at the inlet channel wall. This hydrolysis gas-phase zone is coated with sufficient washcoat and catalyst to assist in decomposing the urea into ammonia. The inlet channel wall also has a soot caking zone 652, which has a highly uniform arrangement of pores for efficiently trapping soot 653. The soot caking zone 652 is typically at or near the inlet channel wall. Depending on how the hydrolysis catalyst was deposited, the hydrolysis gas-phase zone typically will extend from the surface of the inlet channel wall into the channel wall.

After passing through the hydrolysis gas-phase zone 655, the gas is received into an NOx/ammonia conversion zone 660. The NOx/ammonia conversion zone 660 has been heavily loaded with a washcoat and an appropriately selected catalyst. The NOx/ammonia conversion zone 660 is constructed to have a highly uniform open cell network, which facilitates a heavy loading of washcoat and catalyst, without providing an undue back pressure to the engine. The catalyst has been selected according to efficiency requirements, as well as expected performance and environmental conditions. As previously described, this catalyst may be platinum, palladium, rhodium, zeolites, vanadia, barium oxide/nitrate or other NOx reduction/ammonia catalyst. The catalyst assists in reacting NOx and ammonia to form nitrogen gas and water, which is passed into outlet channel 665. Prior to being received into the outlet channel, the gases pass through an oxidation gas-phase zone 663. In providing the oxidation gas-phase zone 663, the uniformly arranged open pore structure adjacent to the outlet channel wall has been coated with a catalyst to assist an oxidation process, such as converting carbon monoxide to carbon dioxide. It will be appreciated with other types of catalytic processes may be supported.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. An SCR-filter, comprising:
an arrangement of bonded fiber structures forming inlet and outlet channels that are separated by respective channel walls;
a soot capture zone on at least some of the channel walls constructed to enable a highly uniform loading of soot;
a NOx-reaction zone inside at least some of the channel walls constructed to enable a highly uniform loading of catalyst;
a NOx reduction catalyst in the NOx-reaction zone for reacting NOx and ammonia to form nitrogen gas and water.

2. The SCR-filter according to claim 1, wherein the soot capture zone comprises the bonded fiber structures arranged to form a highly uniform set of pores that are exposed at the surface of the channel walls of the multi-function filter.

3. The SCR-filter according to claim 1, wherein the NOx-reaction zone comprises the bonded fiber structures arranged to form a highly uniform set of pores inside the channel walls of the multi-function filter.

4. The SCR-filter according to claim 1, wherein the bonded fiber structures are one selected from the group consisting of: i) individual fibers bonded at intersecting nodes, ii) fiber bundles cooperating with each other or individual fibers, iii) elongated single crystal fiber-like structures, and iv) elongated polycrystalline fiber-like structures.

5. The SCR-filter according to claim 1, wherein the bonded fiber structures have a fiber composition comprising a metal, a ceramic, SiC, Al2O3, or mullite.

6. The SCR filter according to claim 1, wherein the channels are arranged in a honeycomb pattern.

7. The SCR filter according to claim 1, wherein the channels are extruded in a honeycomb pattern.

8. The SCR-filter filter according to claim 1, wherein the soot capture zone consists of side walls of inlet channels.

9. The SCR-filter filter according to claim 1, wherein the soot capture zone comprises a cake filter on the side wall of respective inlet channels.

10. The SCR filter according to claim 1, wherein the soot capture zone extends into the channel wall.

11. The SCR filter according to claim 10, wherein the soot capture zone and the NOx-reaction zone overlap.

12. The SCR-filter according to claim 1, wherein the soot capture zone comprises side walls of inlet channels, and the side walls further comprise fibers arranged according to frictional contact with die openings of an extrusion machine.

13. The SCR-filter according to claim 1, wherein the NOx-reaction zone comprises an open cell network arranged to generate a tortuous flow path for an exhaust gas.

14. The SCR-filter according to claim 1, wherein the NOx-reaction zone comprises a substrate structure of bonded fibers or fiber-like structures.

15. The SCR-filter according to claim 1, wherein the NOx-reaction zone comprises more than about 20 grams/cu. ft. of the NOx reduction catalyst.

16. The SCR-filter according to claim 1, wherein the NOx-reaction zone comprises platinum, zeolites, vanadia, Cu/Fe substituted zeolites, or vanadium as the NOx reduction catalyst.

17. The SCR-filter according to claim 1, further comprising a second gas conversion zone having a second catalyst.

18. The SCR-filter according to claim 17, wherein the second gas conversion zone is an oxidation zone, and the second catalyst is an oxidation catalyst.

19. The SCR-filter according to claim 17, wherein the second gas conversion zone is an ammonia conversion zone, and the second catalyst is an ammonia-slip catalyst.

20. The SCR-filter according to claim 17, wherein the second gas conversion zone is a urea decomposition zone, and the second catalyst is an hydrolysis catalyst.

21. The SCR-filter according to claim 17, wherein the second conversion zone is inside the channel walls and positioned downstream from the NOx-reaction zone.

22. The SCR-filter according to claim 17, wherein the second conversion zone is inside the channel walls and positioned upstream from the NOx-reaction zone.

23. The SCR-filter according to claim 17, wherein the second conversion zone catalyst and the NOx reduction catalyst are layered on the fiber structure.

24. The SCR filter according to claim 17 wherein the second conversion zone is adjacent to the gas inlet of the SCR filter and the NOx reaction zone is adjacent to the outlet of the multifunction filter.

25. The SCR filter according to claim 17 wherein the NOx reaction zone is adjacent to the gas inlet of the SCR filter and the second conversion zone is adjacent to the outlet of the multifunction filter.

26. The SCR-filter according to claim 1, further comprising a hydrolysis-phase zone having a hydrolysis catalyst for facilitating the decompositions of NOx to ammonia, the hydrolysis-phase zone positioned adjacent the side walls of respective inlet channels.

27. A NOx control system for an internal combustion engine, comprising:
an inlet for receiving an exhaust gas, the exhaust gas comprising soot and NOx;
a mixing area for mixing urea with the hot exhaust gas to form ammonia;
a fibrous substrate comprised of an organized arrangement of bonded fiber-structures for receiving the NOx, ammonia., and soot;
a soot filtering zone on the fibrous substrate for collecting the soot;
a NOx-conversion zone in the fibrous substrate that is loaded with a NOx reduction catalyst selected to assist in reacting the NOx and ammonia to form nitrogen and water; and
an engine control system for metering the urea.

28. The NOx control system according to claim 27, further including an oxidation phase zone in the fibrous substrate that is loaded with an oxidation catalyst selected to convert CO to CO₂.

29. The NOx control system according to claim 27, further including a hydrolysis phase zone in the fibrous substrate that is loaded with a hydrolysis catalyst selected to decompose urea to ammonia.

30. The NOx control system according to claim 27, wherein the fibrous substrate is constructed from i) individual fibers bonded at intersecting nodes, ii) fiber bundles cooperating with each other or individual fibers, iii) elongated single crystal fiber-like structures, or iv) elongated polycrystalline fiber-like structures.

31. A method for soot and NOx emission control, comprising the steps of:
receiving an exhaust gas at an inlet channel wall of an SCR-filter substrate, the exhaust gas comprising NOx, ammonia, and soot.
capturing the soot at the inlet channel wall of the substrate in uniformly arranged pores;
receiving the NOx and ammonia into a gas-phase zone inside the channel walls of the substrate where a NOx reduction catalyst facilitates reacting the NOx and ammonia to form nitrogen gas and water; and
exhausting the nitrogen gas into an outlet channel of the substrate.

32. The method according to claim 31, wherein:
the exhaust gas further comprises urea; and
further comprises the step of receiving the urea into a gas-phase zone that is positioned adjacent the inlet channel walls of the substrate where a hydrolysis catalyst facilitates decomposing the urea to ammonia.

33. The method according to claim 31, wherein:
the exhaust gas further comprises CO; and
further comprises the step of receiving the CO into a gas-phase zone that is positioned in the channel walls of the substrate where an oxidation catalyst facilitates reacting the CO to CO₂.

34. An SCR emission control filter constructed for installation on a heavy duty vehicle (>8,500 lbs. gw) that receives an unfiltered exhaust gas from an internal combustion engine and emits a gas having 0.01 g/bhp-hr or less particulate matter and less than 0.20 g/bhp-hr of NOₓ, in compliance with 2010 EPA regulations.

35. The SCR emission control filter according to claim 34, where the internal combustion engine is a diesel engine.

36. The SCR emission control filter according to claim 34, where the internal combustion engine is a gasoline engine.

37. An SCR emission control filter constructed for installation on a Large Goods Vehicle (as defined by the EU) that receives an unfiltered exhaust gas from an internal combustion engine and emits a gas having less than 2.00 g/kWh of NOₓ, in compliance with EuroV regulations.

38. An SCR emission control filter constructed for installation on a light duty commercial vehicle (>1760 kg & <3500 kg) that receives an unfiltered exhaust gas from a diesel internal combustion engine and emits a gas having less than 0.28 g/km of NOₓ, in compliance with EuroV regulations.

39. An SCR emission control filter constructed for installation on a light duty commercial vehicle (>1760 kg & <3500 kg) that receives an unfiltered exhaust gas from a gasoline internal combustion engine and emits a gas having less than 0.082 g/km of NOₓ, in compliance with EuroV regulations.

40. An SCR emission control filter constructed for installation on a light duty commercial vehicle (>1305 kg & <1760 kg) that receives an unfiltered exhaust gas from a diesel internal combustion engine and emits a gas having less than 0.235 g/km of NOₓ, in compliance with EuroV regulations.

41. An SCR emission control filter constructed for installation on a light duty commercial vehicle (>1305 kg & <1760 kg) that receives an unfiltered exhaust gas from a gasoline internal combustion engine and emits a gas having less than 0.075 g/km of NOₓ, in compliance with EuroV regulations.

42. An SCR emission control filter constructed for installation on a light duty commercial vehicle (<1305 kg) or a passenger car (M1) that receives an unfiltered exhaust gas from a diesel internal combustion engine and emits a gas having less than 0.18 g/km of NOₓ, in compliance with EuroV regulations.

43. An SCR emission control filter constructed for installation on a light duty commercial vehicle (<1305 kg) or a passenger car (M1) that receives an unfiltered exhaust gas from a gasoline internal combustion engine and emits a gas having less than 0.06 g/km of NOₓ, in compliance with EuroV regulations.
